(19) United States
(12) Patent Application Publication
(10) Pub. No.: US 2025/0128463 A1
(43) Pub. Date: Apr. 24, 2025

(54) MULTILAYER FILMS

(71) Applicant: Dow Global Technologies LLC, Midland, MI (US)

(72) Inventors: Bo Liu, Lake Jackson, TX (US); Feng Chen, Shanghai (CN); Rongjuan Cong, Lake Jackson, TX (US); Wesley R. Mariott, Manvel, TX (US)

(21) Appl. No.: 18/685,043

(22) PCT Filed: Dec. 16, 2021
(86) PCT No.: PCT/CN2021/138743

§ 371 Date: Feb. 20, 2024

(51) Int. Cl. B29C 48/21; B29C 31/10; B29C 48/00; B29C 48/08; B29K 23/00

(52) U.S. Cl. CPC B29C 48/21; B29C 31/10; B29C 48/0017; B29C 48/022; B29C 48/08; B29K 2023/0625; B29K 2023/0633; B29K 2995/0018; B29K 2995/0022; B29K 2995/0063; B29K 2995/0081; B29K 2995/0089

(57) ABSTRACT

A multilayer film comprising at least three film layers including: (a) at least a first polyolefin film layer, wherein the first polyolefin film layer comprises a first outer film layer; (b) at least a second polyolefin film layer, wherein the second polyolefin film layer comprises a core film layer; and (c) at least a third polyolefin film layer, wherein the third polyolefin film layer comprises a second outer film layer; wherein the at least a third polyolefin film layer is the same or different than the at least first polyolefin film layer; wherein the at least second core polyolefin film layer is disposed in between, and separates, the first and third film layers; wherein the first, second and third film layers are contacted together to form a multilayer film structure; wherein at least one of the polyolefin film layers of the three-layer film structure is prepared from a polymer blend composition comprising: (i) at least a first ethylene-based polymer resin; wherein the at least first ethylene-based polymer resin comprises a catalyzed linear low density polyethylene having an altered molecular structure prepared using a Ziegler-Natta Catalyst System 1, which is prepared as described in Preparation 1 in the description; and (ii) at least a second ethylene-based polymer resin; wherein the at least second ethylene-based polymer resin comprises a low density polyethylene resin; and wherein the multilayer film comprising a catalyzed linear low density polyethylene having an altered molecular structure prepared using a Ziegler-Natta Catalyst System 1, which is prepared as described in Preparation 1 in the description, exhibits at least a 10 percent increase in puncture resistance compared to the puncture resistance of a multilayer film that include a catalyzed linear low density polyethylene resin having a non-altered molecular structure prepared using a Ziegler-Natta catalyst; a process for preparing the multilayer film; and an article made from the multilayer film.

### FIELD

The present invention relates to multilayer film structures and more specifically, the present invention relates to polyethylene-based multilayer film structures having enhanced mechanical properties. The multilayer film structures of the present invention are useful, for example, in packaging applications.

### BACKGROUND

Heretofore, known multilayer film articles have been typically used in the packaging industry to manufacture packages for packing bulky and heavy materials. The packages made from multilayer films are required to have enough mechanical and abuse resistance properties to withstand the forces and loads that the packages suffer during shipping and storage of such packages. Stiffer and tougher films used for packaging (e.g., in heavy-duty shipping sack applications) would be beneficial on package load increasement and impact/tear resistance improvement.

Some of the polyolefin resins traditionally used in the fabrication of multilayer films include conventional linear low density polyethylene (LLDPE) resin and low density polyethylene (LDPE) resin. In the multilayer fabrication process, LDPE is usually blended with the LLDPE to improve processability/bubble stability during multilayer film fabrication. In addition, LDPE can increase the optical properties of multilayer films; however, simultaneously LDPE can reduce the multilayer film physical performance such as in the film's toughness property. Therefore, the film manufacturing industry is constantly seeking multilayer film structures, made from LLDPE and LDPE resins, that provide an enhanced film performance such as toughness, particularly for use in packaging applications.

Generally, various known catalysts are employed in the production of a broad range of LLDPE and HDPE products. For example, some of the known catalysts include Ziegler-Natta catalysts, chromium catalysts, single site metallocene catalysts, advanced unimodal and bimodal multi-component catalysts. Many of the above known catalysts are manufactured and supplied by Univation Technologies, LLC. Some of the known catalysts are described, for example, in WO2019241044; U.S. Pat. No. 8,722,804 B2; and U.S. Patent Application Publication No. 2013/0245201 A1.

Some of the above known catalysts provide films with one or more improved properties including improved optical properties such as decreased haze and/or increased clarity; and/or improved abuse properties such as increased dart impact and/or increased resistance to tear in machine direction (MD) or transverse direction (TD) as mentioned in WO2019241044; improved cling performance mentioned in U.S. Pat. No. 8,722,804 B2; and improved TD tear as mentioned in U.S. Patent Application Publication No. 2013/0245201 A1. However, not all of the above catalysts are known to be useful for producing a LLDPE used to fabricate a multilayer film with an enhanced film performance.

Therefore, it is desired to provide a multilayer film structure exhibiting enhanced film performance properties; wherein the multilayer film structure has at least one film layer made from a polyethylene-based polymer resin blend composition including a Zeigler-Natta catalyzed LLDPE resin and a low density polyethylene (LDPE) resin.

### SUMMARY

One general embodiment of the present invention is directed to a multilayer film including at least the following three polyolefin layers: (a) at least a first polyolefin layer comprising a first outer film layer of the multilayer film; (b) at least a second polyolefin layer comprising a core film layer of the multilayer film; and (c) at least a third polyolefin layer comprising a second outer film layer of the multilayer film. The at least third polyolefin layer of the multilayer film may be the same or different than the at least first polyolefin layer of the multilayer film. The at least second polyolefin layer of the multilayer film comprising a core film layer of the multilayer film may be disposed in between, and separates, the at least first outer film layer of the multilayer film and the at least third outer film layer of the multilayer film. The two outer film layers of the multilayer film and the core film layer of the multilayer film are contacted together to form the multilayer film structure of the present invention.

In one preferred embodiment of the present invention includes the above multilayer film structure having the three or more polyolefin film layers; wherein, at least one of the three or more polyolefin film layers of the multilayer film structure is fabricated from a polyethylene-based polymer resin blend composition including: a Zeigler-Natta-catalyzed LLDPE resin with an improved and/or optimized molecular structure as a first component; and a LDPE resin as a second component.

Another embodiment of the present invention includes a process for producing the above multilayer film.

Still another embodiment of the present invention includes a packaging article made using the above multilayer film. For example, the packaging article can be a heavy-duty shipping sack for use in packaging applications.

One of the objectives of the present invention is to produce a multilayer film structure having at least one film layer comprising a polyethylene-based polymer resin blend composition of: (1) an enhanced performance Zeigler-Natta-catalyzed LLDPE resin and (2) a LDPE resin. When the above polyethylene-based polymer resin blend composition is incorporated into at least one polyolefin film layer of the multilayer film structure, the resultant polyolefin film layer of the multilayer film structure made from the resin blend composition, advantageously and surprisingly provides multilayer films with improved performances including a combination and balance of improved optical, toughness, and heat seal performance in multilayer films.

### BRIEF DESCRIPTION OF THE DRAWINGS

FIG. 1 is a schematic cross-sectional view of a multilayer film structure comprising three film layers.

FIG. 2 is a schematic cross-sectional view of a multilayer film structure comprising seven film layers.

### DETAILED DESCRIPTION

Specific embodiments of the present invention are described herein below. These embodiments are provided so that this disclosure is thorough and complete; and fully conveys the scope of the subject matter of the present invention to those skilled in the art.

Unless stated otherwise or to the contrary, implicit from the context, or customary in the art, all percentages, parts, ratios, and the like values, are based on or defined by weight. For example, all percentages stated herein are weight percentages (wt %), unless otherwise indicated.

All test methods are current as of the filing date of this disclosure.

All temperatures used herein are in degrees Celsius (° C.).

“Room temperature (RT)” and “ambient temperature” herein means a temperature between 20° C. and 26° C., unless specified otherwise.

The term “composition,” as used herein, refers to a mixture of materials which comprises the composition, as well as reaction products and decomposition products formed from the materials of the composition.

The term “polymer” refers to a polymeric compound prepared by polymerizing monomers, whether of a same or a different type. The generic term “polymer” thus embraces (1) the term “homopolymer,” which usually refers to a polymer prepared from only one type of monomer; and (2) the term “copolymer,” which refers to a polymer prepared from two or more different monomers. The term “interpolymer,” as used herein, refers to a polymer prepared by the polymerization of at least two different types of monomers. The generic term “interpolymer” thus includes a copolymer or polymer prepared from more than two different types of monomers, such as terpolymers.

“Polyethylene” or “ethylene-based polymer” shall mean polymers comprising greater than 50% by mole of units which have been derived from ethylene monomer. This includes ethylene-based homopolymers or copolymers (meaning units derived from two or more comonomers). Common forms of ethylene-based polymers known in the art include, but are not limited to, Low Density Polyethylene (LDPE); Linear Low Density Polyethylene (LLDPE); single-site catalyzed Linear Low Density Polyethylene, including both linear and substantially linear low density resins (m-LLDPE); Medium Density Polyethylene (MDPE); and High Density Polyethylene (HDPE). The “polyethylene” or “ethylene-based polymer” useful in the present invention has at least 50 wt % ethylene-derived units in one embodiment, at least 70 wt % ethylene-derived units in another embodiment, at least 80 wt % ethylene-derived units in still another embodiment, and at least 90 wt % ethylene-derived units in still another embodiment.

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see, for example, U.S. Pat. No. 4,599,392, which is hereby incorporated by reference). LDPE resins typically have a density in the range of 0.916 g/cm³ to 0.940 g/cm³.

The term “LLDPE,” includes resin made using Ziegler-Natta catalyst systems as well as resin made using single-site catalysts, including, but not limited to, bis-metallocene catalysts (sometimes referred to as “m-LLDPE”), phosphinimine, and constrained geometry catalysts, and resins made using post-metallocene, molecular catalysts, including, but not limited to, bis(biphenylphenoxy) catalysts (also referred to as polyvalent aryloxyether catalysts). LLDPE includes linear, substantially linear, or heterogeneous ethylene-based copolymers. LLDPEs contain less long chain branching than LDPEs and include the substantially linear ethylene polymers, which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and blends thereof (such as those disclosed in U.S. Pat. Nos. 3,914,342 and 5,854,045). The LLDPE resins can be made via gas-phase, solution-phase, or slurry polymerization or any combination thereof, using any type of reactor or reactor configuration known in the art.

The term “MDPE” refers to polyethylenes having densities from 0.924 g/cm³ to 0.942 g/cm³. “MDPE” is typically made using chromium or Ziegler-Natta catalysts or using single-site catalysts including, but not limited to, substituted mono- or bis-cyclopentadienyl catalysts (typically referred to as metallocene), constrained geometry catalysts, phosphinimine catalysts and polyvalent aryloxyether catalysts (typically referred to as bisphenyl phenoxy).

The term “HDPE” refers to polyethylenes having densities greater than about 0.935 g/cm³ and up to about 0.980 g/cm³, which are generally prepared with Ziegler-Natta catalysts, chrome catalysts or single-site catalysts including, but not limited to, substituted mono- or bis-cyclopentadienyl catalysts (typically referred to as metallocene), constrained geometry catalysts, phosphinimine catalysts & polyvalent aryloxyether catalysts (typically referred to as bisphenyl phenoxy).

The term “ULDPE” refers to polyethylenes having densities of 0.855 g/cm³ to 0.912 g/cm³, which are generally prepared with Ziegler-Natta catalysts, chrome catalysts, or single-site catalysts including, but not limited to, substituted mono- or bis-cyclopentadienyl catalysts (typically referred to as metallocene), constrained geometry catalysts, phosphinimine catalysts & polyvalent aryloxyether catalysts (typically referred to as bisphenyl phenoxy). ULDPEs include, but are not limited to, polyethylene (ethylene-based) plastomers and polyethylene (ethylene-based) elastomers. Polyethylene (ethylene-based) elastomers plastomers generally have densities of 0.855 g/cm³ to 0.912 g/cm³.

“Blend,” “polymer blend,” and like terms, with reference to a polymer composition, mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend. Such blends can be prepared as dry blends, formed in situ (e.g., in a reactor), melt blends, or using other techniques known to those of skill in the art.

“Multilayer structure” or “multilayer film” means any structure having more than one layer. For example, the multilayer structure (for example, a film) may have two, three, four, five, or more layers. A multilayer structure may be described as having the layers designated with letters. For example, a three-layer structure designated as A/B/C may have a core layer, B, and two external layers, A and C. Likewise, a structure having two core layers, B and C, and two external layers, A and D, would be designated A/B/C/D.

The term “molecular weight distribution” means the same thing as polydispersity index (PDI). The molecular weight distribution of a polymer resin is the ratio of weight-average molecular weight (Mw) to number-average molecular weight (Mn), i.e., Mw/Mn. Mw, Mn, and Mz can be measured using gel permeation chromatography (GPC), also known as size exclusion chromatography (SEC). Measurement of molecular weight by SEC is well known in the art.

The term “toughness”, with reference to a film structure, herein is correlated to the puncture value determined according to procedure described in ASTM D5748-95.

The term “stiffness”, with reference to a film structure, herein is correlated to the secant modulus value of the film determined according to the procedure described in ASTM D882-18.

A “modified or altered molecular structure (AMS)” when used in reference to a catalyzed LLDPE, herein means, a LLDPE catalyzed with a Zeigler-Natta (ZN) catalyst or catalyst system described in WO2019241044A1.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; and the like).

As used throughout this specification, the abbreviations given below have the following meanings, unless the context clearly indicates otherwise: “=” means “equal(s)” or “equal to”; “<” means “less than”; “>” means “greater than”; “<” means “less than or equal to”; “>” means “greater than or equal to”; “®” means “at”; “MT=metric ton(s); g=gram(s); mg=milligram(s); Kg=kilogram(s); g/L=gram(s) per liter; “g/cm³” or “g/cc”=gram(s) per cubic centimeter; “kg/m³=kilogram(s) per cubic meter; ppm=parts per million by weight; pbw=parts by weight; rpm=revolutions per minute; m=meter(s); mm=millimeter(s); cm=centimeter(s); μm=micron(s), min=minute(s); s=second(s); ms=millisecond(s); hr=hour(s); Pa=pascals; MPa=megapascals; Pa·s=Pascal second(s); mPa·s=milliPascal second(s); g/mol=gram(s) per mole(s); g/eq=gram(s) per equivalent(s); Mₙ=number average molecular weight; M_{w}=weight average molecular weight; M_{z}=Z average molecular weight; pts=part(s) by weight; 1/s or sec⁻¹=reciprocal second(s) [s⁻¹]; ° C.=degree(s) Celsius; psig=pounds per square inch; kPa=kilopascal(s); %=percent; vol %=volume percent; mol %=mole percent; and wt %=weight percent.

In one broad embodiment, the multilayer film of the present invention comprises at least three layers including: at least a first polyolefin layer, at least a second polyolefin layer, and at least a third polyolefin layer, and two or more of the first, second and third polyolefin layers can be the same or different.

In some embodiments, each of the polyolefin layers making up the multilayer film of the present invention is prepared from a polyolefin resin composition. In a preferred embodiment, the polyolefin resin composition of each of the polyolefin layers making up the multilayer film of the present invention includes at least one or more ethylene-based polymer resins. In another preferred embodiment, the ethylene-based polymer resin composition of each of the polyolefin layers making up the multilayer film of the present invention includes at least one or more LLDPE polymer resins. The LLDPE polymer resin used in at least one of the at least three polyolefin layers of the multilayer film comprises a catalyzed LLDPE. The catalyzed LLDPE useful in the present invention has a modified or altered molecular structure (AMS) that provides a multilayer film with improved or enhanced performances.

The catalyzed LLDPE having an AMS, in general, is prepared by catalyzing a LLDPE resin using a certain type of Zeigler-Natta catalyst that forms a catalyzed LLDPE having an AMS. The Zeigler-Natta (ZN) catalyst that forms a catalyzed LLDPE having an AMS is a ZN catalyst that is similar to other various ZN catalysts; however, the ZN catalyst used in the present invention to form the catalyzed LLDPE having an AMS is separate and distinct from other ZN catalysts. Thus, the ZN-catalyzed LLDPE of the present invention catalyzed with a variation of a ZN catalyst (described herein below) is herein referred to as an “ZN-catalyzed AMS-LLDPE” or further abbreviated “ZN-AMS-LLDPE” polymer resin.

In one preferred embodiment, the ZN catalyst used to prepare the ZN-AMS-LLDPE polymer resin composition comprises a Ziegler-Natta Catalyst System 1, which is a ZN catalyst prepared as described in Preparation 1 as follows:

### Preparation 1: Preparation of Zieqler-Natta Catalyst System 1

Without being bound by theory, it is believed that any ZN catalyst system described in WO 2019/241044 A1 could be adopted without undue experimentation for use in a method of catalyzing a LLDPE to form the ZN-AMS-LLDPE polymer resin (also referenced as Resin B and Resin1) of the present invention. The Ziegler-Natta Catalyst System 1 is a catalyst or catalyst system used for catalyzing a LLDPE to form the ZN-AMS-LLDPE polymer resin.

The Ziegler-Natta Catalyst System 1 and its preparation is disclosed in WO2019241044 Inventive Example 1a (IE 1a) except that the catalyst (Ziegler-Natta Catalyst System 1) used to catalyze the LLDPE of the present invention is prepared on a commercial scale. In accordance with Inventive Example IE 1a of WO2019241044, the synthesis of a spray-dried Ziegler-Natta procatalyst system is disclosed which is the same catalyst (Ziegler-Natta Catalyst System 1) as the catalyst used in the present invention. In general, the process of synthesizing the spray-dried Ziegler-Natta procatalyst system includes first preparing a spray-dried particulate solid consisting essentially of a hydrophobic fumed silica, MgCl₂, and THF using “Preparation 1 (Prep1)” disclosed in WO2019241044. Then, 150 g of the spray-dried particulate solid, 520 g of a mineral oil, and 8.7 g of Ti(OiPr)₄ are mixed at 30° C. for 0.5 hr to give an intermediate mixture consisting essentially of, or being a reaction product made from, the spray-dried particulate solid, mineral oil, and Ti(OiPr)₄. The intermediate mixture is free of ethylaluminum dichloride (EADC). Then, the intermediate mixture is combined with 73.5 g of EADC at 30° C. for 2 hr to give the spray-dried Ziegler-Natta procatalyst system of IE1a in mineral oil.

### Preparation 2: Preparation of ZN-AMS-LLDPE Polymer Resin

In general, the preparation of the ZN-AMS-LLDPE Polymer Resin useful in the present invention. Includes using the Ziegler-Natta Catalyst System 1 (based on the catalyst disclosed in WO2019241044 Inventive Example 1a (IE 1a)) prepared above to catalyze a LLDPE. In some embodiments, the Ziegler-Natta Catalyst System 1 catalyst is injected into a gas phase polymerization reactor in the presence of a compound selected from the group consisting of ethylene, butene, hydrogen, nitrogen, isopentane and mixtures thereof, whereby the polymerization reactor contents undergo polymerization to form a polyethylene and butene copolymer. The reaction is carried out at the polymerization reactor conditions described in Table I. The polyethylene and butene copolymer resin is then purged under nitrogen to remove residual hydrocarbons. Then, the resin was compounded with other ingredients using a twin screw extruder LCM100 and an underwater pelletizing cutter hub. The aforementioned other ingredients which are added to the resin include, for example, Irgafos®168 and Preblend 9K (both additives are available from BASF).

In another preferred embodiment, at least one of the at least three polyolefin layers of the multilayer film is formed from a resin blend of at least two or more polyolefin polymer resins. For example, in one preferred embodiment, the at least two or more polyolefin polymer resins used to form the at least one of the three polyolefin layers of the multilayer film includes a polymer blend composition of: (i) at least one of the above-described ZN-AMS-LLDPE polymer resin; and (ii) at least one LDPE polymer resin.

When one of the three or more polyolefin layers of the multilayer film is formed from a blend of two or more polyolefin polymer resins comprising the combination of: (1) the at least one ZN-AMS-LLDPE resin (Resin1) and (2) the at least one LDPE polymer resin (Resin2), the other remaining layer or layers of the multilayer film can be formed from the same or different polymer resins. For example, the other remaining layer or layers of the multilayer film can be formed from at least one or more optional polymer resins (Resin3) selected from the group consisting of: (i) the ZN-AMS-LLDPE resin; (ii) another different Zeigler-Natta (ZN) catalyzed LLDPE resin (abbreviated herein “ZN-LLDPE resin”); (iii) a metallocene catalyzed LLDPE resin (abbreviated herein “mLLDPE resin”); (iv) another different metallocene catalyzed LLDPE resin with long chain branching (LCB) (abbreviated herein “mLLDPE-LCB resin”) which is a metallocene catalyzed LLDPE resin having a LCB value of from 0.001/1000 carbons to <0.1/1000 carbons; (v) a LDPE resin; (vi) a VLDPE resin; (vii) a ULDPE resin; (viii) a MDPE resin; (ix) a HDPE resin; (x) another different LLDPE resin; (xi) a HDPE resin, and (xii) mixtures thereof.

The ZN-AMS-LLDPE resin (“Resin1”), of the polymer resin blend composition used in at least one of the layers of the multilayer film structure has the following characteristics:
(a) a butene comonomer is used in preparing the ZN-AMS-LLDPE resin, and thus, the resultant polymer resin is a poly(ethylene-co-1-butene) copolymer resin;
(b) a density of from 0.910 g/cm³ to 0.935 g/cm³ in one general embodiment; alternatively, from 0.915 g/cm³ to 0.925 g/cm³ in another embodiment; and alternatively, from 0.918 g/cm³ to 0.922 g/cm³ in still another embodiment;
(c) a melt index (designated MI; I2, I₂, or MI2) of from 0.8 g/10 min to 2.8 g/10 min in one general embodiment; alternatively, from 1.5 g/10 min to 2.5 g/10 min in another embodiment; and alternatively, from 1.7 g/10 min to ˜2.2 g/10 min;
(d) a molecular weight distribution (M_{w}/Mₙ) is greater than (>) 3 up to less than (<) 5 in one general embodiment;
(e) a (M_{z}/M_{w}) is >2.5 up to <5 in one general embodiment, and >2.5 up to <4 in another embodiment;
(f) a CUMCDI in the range of −1.0 to −0.1;
(g) a wt % (93.0° C. to 120.0° C.)/wt % (75° C. 93.0° C.) by iCCD<0.26;
(h) a molecular weight (M_{w}) (>93.0° C.) divided by the whole polymer, as measured by the comonomer content distribution (iCCD) analysis method, of <2.0 in one embodiment; <1.9 in another embodiment; and <1.7 in still another embodiment; and
(i) a wt % (>93.0° C.) by iCCD in the range of from 3% to 15% in one general embodiment.

In addition to the above features (a) to (i) exhibited by the ZN-AMS-LLDPE resin as described above, the ZN-AMS-LLDPE resin may also have one or more of the following optional characteristics:
(j) a wt % (25.0° C.˜37.0° C.) by iCCD in the range of 2.0% to 8.0% in one general embodiment; and from 3.0% to 7.0% in another embodiment;
(k) a wt % (75.0° C. 93.0° C.) by iCCD of more than 41.5% in one general embodiment; >45% in another embodiment; and >46.0% in still another embodiment;
(l) produced using a Zeigler-Natta catalyst or catalyst system, as described in WO2019241044, from a gas phase process; and
(m) the ZN-AMS-LLDPE resin is made by a process similar to the “UNIPOL™ PE Process” using a Ziegler-Natta type catalyst (available from Univation).

The LDPE resin (“Resin2”), of the polymer resin blend composition used in at least one of the layers of the multilayer film structure has the following characteristics:
(a) a density of from 0.915 g/cc to 0.927 g/cc in one general embodiment; and
(b) a melt index, I2, of from 0.8 g/10 min to 2.5 g/10 min in one general embodiment; alternatively, from 1.5 g/10 min to 2.5 g/10 min in another embodiment; and alternatively, from 1.8 g/10 min to ˜2.2 g/10 min in still another embodiment.

In addition to Resin1 and Resin2, the polymer resin blend composition may include one or more optional polymer resins (“Resin3”), such as one or more of the resins (i) to (xii) described above. The Resin1 and Resin2; and optionally Resin3, are used in at least one of the layers of the multilayer film structure. For example, other polyethylene resins, such as a LLDPE resin, a HDPE resin, and mixtures thereof, may optionally be included in the polymer resin blend composition used for fabricating any one, more than one, or all of the above-described three layers of the multilayer film structure. In other embodiments, optionally additional layers may be added to the 3-layer multilayer film structure; and the optional additional layer or layers can include the any one, more than one, or all of the resins, Resin1, Resin2 and optional Resin3.

The polymer resin compositions (Resin1, Resin2 and optional Resin3) used to form each of the layers of the multilayer film of the present invention may optionally include any number of additional components, agents, or additives therein. Thus, one, two or all of the polymer resin compositions used to form the layers of the multilayer film may include one or more optional components. For example, one or more other different polyolefin polymer resins may be added to the polymer resin composition used to form the first, second and/or third layers. In some embodiments, the optional polymer resin can be, for example, another LLDPE polymer resin different from Resin1, another LDPE polymer resin different from Resin2, a medium density polyethylene (MDPE) polymer resin, and/or a high density polyethylene (HDPE) polymer resin. In some embodiments, for example, a high density polyethylene (HDPE) component having a density of from 0.940 g/cm³ to 0.980 g/cm³ and a melt index (I₂) of from 0.1 g/10 min to 1.5 g/10 min can be incorporated in the core layer of the multilayer film structure.

In other embodiments, the compositions used to form the first, second and/or third layers may also optionally contain one or more conventional additives including, for example, lubricants, antioxidants, ultraviolet light-promoted degradation inhibitors (“UV stabilizers”), hindered amine stabilizers, acid scavengers, nucleating agents, anti-blocking agents such as silica or talc, processing aids, metal deactivators, dyes, pigments, colorants, anti-fog agents, anti-static agents, plasticizers, viscosity stabilizers, hydrolytic stabilizers, ultraviolet light absorbers, inorganic fillers, fire-retardants, reinforcing agents such as glass fiber and flakes, synthetic (for example, aramid) fiber or pulp, foaming agents, blowing agents, slip additives, release agents, tackifying resins, and combinations of two or more thereof.

In some embodiments, the polymer resin composition used to form the first layer, the second layer, the third layer, and combinations thereof may each include up to 5 wt % of any of the above additional optional additives, based on the total weight of the respective layer. For example, the concentration of the optional additive in the first layer, the second layer, the third layer, and combinations thereof may be from 0 wt % to 5 wt % in one embodiment, from 0.1 wt % to 5 wt % in another embodiment, and from 0.5 wt % to 5 wt % in still another embodiment, based on the total weight of the respective layer. The incorporation of the optional additive can be carried out by any known process such as, for example, by dry blending, by extruding a mixture of the various constituents, by the conventional masterbatch technique, and the like.

As one illustration of the present invention and not to be limited thereby, a 3-layer multilayer film structure including a surface layer, a core layer, and an inner layer, can be produced with a predetermined amount/content of Resin1 and Resin2; and optionally Resin3. For example, the surface layer of the 3-layer multilayer film structure can include Resin1; and the content of Resin1 in the surface layer can be from 30 wt % to 98 wt % in one general embodiment, alternatively, from 55 wt % to 95 wt % in another embodiment; and alternatively, from 85 wt % to ˜95 wt % in still another embodiment. For example, the core layer of the 3-layer multilayer film structure can also include Resin1; and the content of Resin1 in the core layer can be from 30 wt % to 100 wt %; alternatively, from 65 wt % to 100 wt % in another embodiment; and alternatively, from 85 wt % to ˜100 wt % in still another embodiment. For example, the inner layer of the 3-layer multilayer film structure can also include Resin1; and the content of Resin1 in the inner layer can be from 30 wt % to 98 wt % in one general embodiment, alternatively, from 55 wt % to 95 wt % in another embodiment; and alternatively, from 85 wt % to ˜95 wt % in still another embodiment.

Exemplary of some of the above-described resins (i)-(xii) useful in the present invention may include, but not limited to, the following resins:
(1) a ZN catalyzed LLDPE resin, such as ZN-LLDPE DFDA-7047 (available from Univation), which is a poly(ethylene-co-1-butene) copolymer resin having a density of 0.918 g/cm³ and a melt index of 1 g/10 min; and made by the “UNIPOL™ PE Process” using a Ziegler-Natta catalyst, such as UCAT™ J catalyst (available from Univation);
(2) another ZN catalyzed LLDPE resin, such as ZN-LLDPE DFDA-7042 (available from Univation), which is another poly(ethylene-co-1-butene) copolymer resin having a density of 0.918 g/cm³ and a melt index of 2 g/10 min; and made by the UNIPOL™ PE Process using a Ziegler-Natta catalyst, such as UCAT™ J catalyst (available from Univation);
(3) a mLLDPE resin, such as MCN-LLDPE HPR 1018HA (available from Univation), which is a poly(ethylene-co-1-hexene) copolymer resin having a density of 0.918 g/cm³ and a melt index of 1 g/10 min; and made by the UNIPOL™ PE Process using a metallocene catalyst, such as XCAT™ HP-100 catalyst (available from Univation);
(4) a HDPE resin, such as HDPE DGDZ-6095 (available from Univation), which is another poly(ethylene-co-1-hexene) copolymer resin having a density of 0.948 g/cm³ and a flow index of 10 g/10 min; and made by the UNIPOL™ PE Process using a chromium catalyst, such as ACCLAIM™ K-100 catalyst (available from Univation);
(5) another mLLDPE resin, such as EZ-LLDPE EZP 2703 (available from Univation), which is another poly(ethylene-co-1-hexene) copolymer resin having a density of 0.928 g/cm³ and a melt index of 0.3 g/10 min; and made by the UNIPOL™ PE Process using a metallocene catalyst, such as XCAT™ EZ-100 catalyst (available from Univation); and the mLLDPE resin, such as EZ-LLDPE EZP 2703, has a LCB value of from 0.001/1000 carbons to <0.1/1000 carbons;
(6) another mLLDPE resin, such as EZ-LLDPE EZP 2010 (available from Univation), another poly(ethylene-co-1-hexene) copolymer resin having a density of 0.922 g/cm³ melt index of 1 g/10 min; and made by the UNIPOL™ PE Process using a metallocene catalyst, such as XCAT™ EZ-100 catalyst (available from Univation); and the mLLDPE resin, such as EZ-LLDPE EZP 2010, has a LCB value of from 0.001/1000 carbons to <0.1/1000 carbons;
(7) a LDPE resin, such as LDPE 150E (available from The Dow Chemical Company), having a density of 0.921 g/cm³ and a melt index of 0.3 g/10 min;
(8) a LDPE resin, such as LDPE 450E (available from The Dow Chemical Company), having a density of 0.923 g/cm³ and a melt index of 2 g/10 min; and
(9) mixtures of any two or more of the above resins (1)-(8).

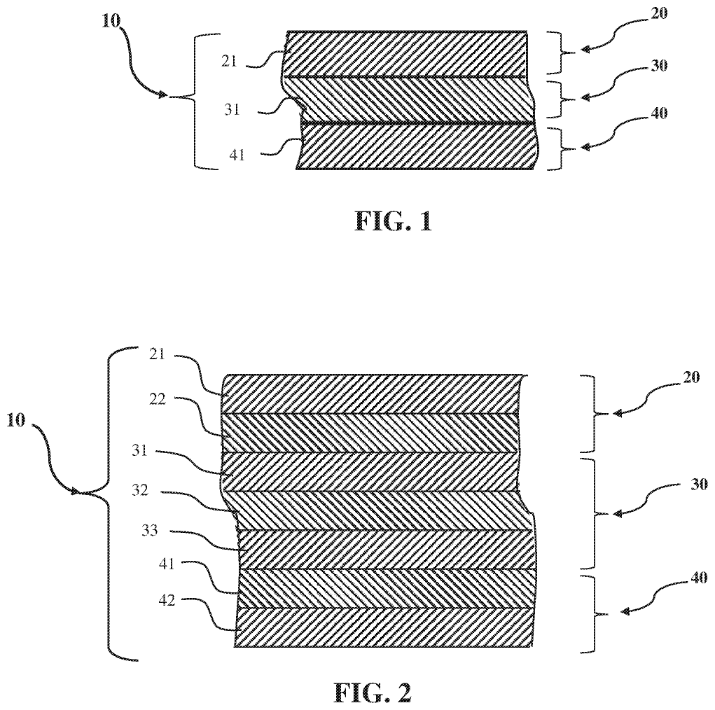

With reference to FIG. 1, there is shown one embodiment of the multilayer film of the present invention, generally indicated by reference numeral 10. In one embodiment, the multilayer film 10 includes a multilayer film having at least 3 layers in the film structure 10. For example, in a preferred embodiment, the 3-layer multilayer film 10 includes: (a) at least a first layer comprising at least a first outer polyolefin layer (a skin layer or top layer), generally indicated by reference numeral 20; (b) at least a second layer comprising at least a core polyolefin layer (a middle layer), generally indicated by reference numeral 30; and (c) at least a third layer comprising at least a second outer polyolefin layer (a skin layer or bottom layer), generally indicated by reference numeral 40. The first outer layer 20 and the second outer layer 40 can be the same or different from each other. As shown in FIG. 1, the core polyolefin layer 30 is disposed in between the first film layer 20 and the second film layer 40, i.e., the two outer layers 20 and 40 sandwich the core layer 30; and the first layer, the second layer, and the third layer (film layers 20, 30 and 40, respectively) are contacted and bonded together to form the multilayer film structure 10.

The outer layers which include the first layer 20 and the third layer 40 may also be referred to as “skin layers” or “external layers”. The outer layer 20 can also be referred to as a “top layer and the outer layer 40 can also be referred to as a “bottom layer”. The core layer 30 which includes the second layer may also be referred to as a “middle layer”. In some embodiments, each of the layers 20, 30 and 40 of the multilayer film of the present invention may be a monolayer; and in another embodiment, each of the layers 20, 30 and 40 of the multilayer film of the present invention may include a plurality of the same monolayers or a combination of different monolayers to form the multilayer film. The term “core” or the phrase “core layer”, refers to any internal film layer in a multilayer film; and the phrase “skin layer” refers to an outermost layer of a multilayer film.

The multilayer film shown in FIG. 1, which comprises the at least three-layer film structure (film layers 20, 30 and 40), can be designated as a film structure of layers A/B/C, wherein the outer layers 20 and 40 may be designated as A and C, respectively; and the core layer 30 may be designated as B. In other embodiments of the above designated 3-layer film structure, the outermost layers (layers A and C) of the multilayer film are in direct contact with the core layer B. In the embodiment of the present invention shown in FIG. 1, each of the layers 20, 30, 40 making up the multilayer film is a monolayer indicated by reference numerals 21, 31 and 41, respectively.

With reference to FIG. 2, there is shown another embodiment of a multilayer (e.g., 2 or more layers) film structure of the present invention wherein the multilayer film is made up of at least seven layers; and the seven layers are used to make up the layers 20, 30, and 40. For example, each of the layers 20, 30, and 40 comprise a multiple number of layers (or sublayers). Thus, the resulting seven-layer multilayer film structure shown in FIG. 2, comprises, for example, two film layers for film 20, three film layers for film 30 and two film layers for film 40. In the embodiment shown in FIG. 2, layer 20 includes an outer layer 21 and an intermediate layer 22 disposed in between the outer layer 21 and the core layer 30; and layer 40 includes an outer layer 41 and an intermediate layer 42 disposed in between the outer layer 41 and the core layer 30. And, in FIG. 2, the core layer 30 comprises a combination of a first core layer 31, a second core layer 32, and a third core layer 33, the core layers being disposed in between the outer layers 20 and 40.

The multilayer film shown in FIG. 2, which comprises the at least a seven-layer film structure can be designated as a film structure of layers A/B/C/D/E/F/G, wherein the outer layer 20 may be designated as film layers A and B; the outer layer 40 may be designated as film layers F and G; and the core layer 30 may be designated as film layers C, D and E. In other embodiments of the above designated 7-layer film structure, the outermost layers, layers A and G, of the multilayer film may include an inner layer B and F, respectively where the inner layers B and F are in direct contact with the core layers C and E, respectively.

The multilayer film structures according to the present invention may include two or more layers. In a preferred embodiment, the multilayer films of the present invention have three or more layers. For example, the multilayer film structures of the present invention may include at least three layers in one embodiment (as shown in FIG. 1); five layers in another embodiment; 7 layers in still another embodiment; and up to as many as 13 layers or more layers in yet other embodiments. The number of layers in the multilayer film may depend on a number of factors including, for example, the composition of each layer in the multilayer film, the desired properties of the multilayer film, the desired end-use application of the multilayer film, the manufacturing process of the multilayer film, and other factors.

In one preferred embodiment, the multilayer film of the present invention is a three-layer film structure designated as a film structure of layers A/B/C (layers 21, 31 and 41, respectively); where the first layer may be designated as A, the second layer may be designated as B, and the third layer may be designated as C.

In some embodiments, the second layer (layer B) may be referred to as a “core layer”; and the core layer may be a monolayer or two or more monolayers (i.e., a multilayer core layer). In some embodiments, one or both of the first layer (layer A) and the third layer (layer C) may be referred to as “skin layers”, “outer layers”, or “inner layers”; and the first layer and the third layer may be a monolayer or two or more monolayers (i.e., a multilayer outer or inner layer). In further embodiments, the first layer and the third layer may be printable layers and/or sealable layers. For example, in some embodiments the first layer and the third layer may both be printable outer layers or both layers may be sealable inner layers; and in other embodiments, the first layer may be a printable outer layer and the third layer may be a sealable inner layer.

In some embodiments, the second layer (core layer) of the multilayer film may be positioned between the first layer and the third layer. In further embodiments, the first layer and the third layer may be the outermost layers of the multilayer film. As used herein, the outermost layers of the multilayer film may be understood to mean there may not be another layer deposited over the outermost layer, such that the outer surface of the outermost layer is in direct contact with the surrounding air and the inner surface of the outermost layer is in direct contact with the core layer. For example, the first layer and the second layer and/or the third layer and second layer may be in direct contact with one another. As used herein, “direct contact” means that there may not be any other layers positioned between two layers that are in direct contact with one another.

In some embodiments, the multilayer film of the present invention may optionally further include one or more additional film layers (in addition to the first layer, the second layer and the third layer). For example, the multilayer film of the present invention may optionally include one or more tie layers, where a tie layer is disposed between the first layer (an outer layer) and the second layer (the core layer); and/or where a tie layer is disposed between the second layer (the core layer) and the third layer (another outer layer or an inner layer).

In some embodiments, the additional optional film layer or layers of the multilayer film structure of the present invention can be the same or different than the first layer, the second layer and/or the third layer. For example, in some embodiments, an optional additional fourth film layer may be included in combination with the three layers (the first layer, the second layer and the third layer) of the multilayer film structure described above. The optional additional fourth film layer and/or any of the optional additional film layers of the present invention, if used, can be a mono-layer film or a multilayer film.

In a multilayer film structure, each layer will serve a particular function or provide some characteristic to the overall multi-layer film structure. The composition of the layers is chosen depending on the intended end use application, cost considerations, and the like. For example, layers may serve to provide particular structural or functional characteristics, e.g., add bulk to the structure, promote interlayer adhesion, provide barrier properties, thermal properties, optic properties, sealing characteristics, chemical resistance, mechanical properties, abuse resistance, and the like.

Accordingly, in some embodiments, optional additional layers useful in the present invention may include, for example, adhesion-promoting interlayers (also referred to as tie layers; barrier films that prevent water or other liquids, oxygen or other gases, light and other elements from permeating through the barrier film; sealant films that are involved in the sealing of the sealant film to itself or the sealing of the sealant film to another layer in a multilayer film; or combinations thereof. In a preferred embodiment, the multilayer film structure of the present invention may, for example, contain tie layers and/or sealant layers.

The optional additional film layer or film layers may be formed from a polymer resin composition such as a polyethylene resin or blend of different polyethylene resins. Illustrative of polyethylenes that can be used to form an optional additional layer, can include, but are not limited to, VLDPE resins, LDPE resins, other LLDPE resins, MDPE resins, HDPE resins, and a combination thereof. For example, in some embodiments, any of the layers of the multilayer film, such as the core layer, may include a HDPE. The HDPE may be incorporated into the core layer to increase the stiffness of the core layer. In some applications, it may be important for the multilayer film to possess adequate stiffness, demonstrated by tensile modulus, for example, to prevent deformation and to prevent breakage.

The thickness of each layer of the multilayer film, and the thickness of the overall multilayer film, is not particularly limited, and may depend on a number of factors including, for example, the number of layers in the multilayer film, the composition of the layers in the multilayer film, the desired properties of the multilayer film, the desired end-use application of the multilayer film, the manufacturing process of the multilayer film, and other factors such as the die gap employed during film casting or film blowing. Thus, the multilayer films of the present invention can have a variety of thicknesses. For example, in some embodiments, each of the layers of the multilayer film may have a thickness of less than less than 1,000 micrometers (μm or microns) in one general embodiment and less than 500 μm in another embodiment. In other embodiments, each of the layers of the multilayer film may have a thickness of from 1 μm to 1,000 μm in one embodiment, from 5 μm to 500 μm in another embodiment, and from 5 μm to 100 μm in still another embodiment.

The overall thickness of the multilayer film may be at an overall thickness of less than 1,000 μm in one general embodiment and less than 500 μm in another embodiment. In other embodiments, the multilayer film may have a thickness of from 1 μm to 1,000 μm in one embodiment, from 5 μm to 500 μm in another embodiment, from 10 μm to 500 μm in still another embodiment, from 15 μm to 500 μm in yet another embodiment, from 5 μm to 100 μm in even still another embodiment, and from 10 μm to 100 μm in even yet another embodiment.

In some embodiments, multilayer polymer films of the present invention, and in some instances the monolayer films used to make up the multilayer films, have a balance of stiffness and toughness that may allow for a reduction of material costs through down-gauging (i.e., using thinner film thicknesses) for various applications such as packaging applications especially when lesser gauges are used (“down-gauging”).

In a broad embodiment, each of the at least three layers of the multilayer film of the present invention is formed from various resins; and, in one embodiment, at least one of the three layers of the multilayer film (i.e., any one or more of the layers of the multilayer film structure) includes a blend of two or more polyolefin polymer resins, where at least one of the layers of the multilayer film includes a polymer resin blend comprising (1) a ZN-AMS-LLDPE resin and (2) a LDPE resin, each resin being present in a predetermined concentration. For example, the outer polyolefin layer (the first layer of the multilayer film), the core polyolefin layer (the second layer of the multilayer film), and/or the sealant polyolefin layer (the third layer of the multilayer film) can include a ZN-AMS-LLDPE resin (Resin1).

Each of the layers making up the multilayer film of the present invention shown in FIG. 1 and FIG. 2 is prepared from a polyolefin resin composition; and in a preferred embodiment, each of the layers is prepared from at least one ethylene-based polymer resin composition which has been described above. In one general embodiment, the ethylene-based polymer resin compositions for each of the layers of the multilayer film structure includes, for example, one or more LLDPEs in each layer, where at least one of the LLDPEs used in the layer or layers making up the multilayer film of the present invention is the above-described ZN-AMS-LLDPE.

For example, in some embodiments, the 3-layer structure, A/B/C, of the multilayer film shown in FIG. 1 includes, for example, the following layers of polymer resin compositions: layer A (first film layer 21) is a polymer resin composition comprising a combination of Resin1, a ZN-AMS-LLDPE resin and Resin2, a LDPE resin; layer B (second film layer 31) is a polymer resin composition comprising Resin1; and layer C (third film layer 41) is a polymer resin composition comprising a combination of Resin1 and Resin2.

In one general embodiment, the first film layer of the multilayer film useful in the present invention can be a monolayer or a combination of two or more monolayers (i.e., a multiple number of layers forming the first film layer of the multilayer film). In addition, the first film layer of the multilayer film useful in the present invention can be formed from a single polyolefin resin or a blend of two or more polyolefin resins. In one embodiment, the first film layer of the multilayer film is formed, for example, from one or more ethylene-based polymer components. In other embodiments, the first layer of the multilayer film comprises a polymer resin blend composition that can be used to fabricate a printable outer skin layer as the first layer.

In another embodiment, the first film layer of the multilayer film is a combination or blend of two or more ethylene-based polymer components selected from two or more of the above-described Resin1 and Resin2 and optionally Resin3 selected from the above-described resins (i) to (xii)). For example, in another embodiment, the first film layer of the multilayer film comprises a polymer resin blend composition of a blend of polyethylene-based resins such as a blend of Resin1 and Resin2. Other optional resins, Resin3, when used, if desired, can be for example, EZ-LLDPE resin; and/or HDPE resin.

In one preferred embodiment, the polymer resin blend composition used for the first film layer of the multilayer film includes a combination of Resin1 and Resin2. With reference to FIG. 1 again, each of the polymer resins (e.g., Resin1, Resin2 and optionally Resin3) in the polymer resin blend used for forming the first polyolefin film layer 20 of the multilayer film 10 has a density ranging from 0.912 g/cm³ to 0.925 g/cm³ in one embodiment; from 0.915 g/cm³ to 0.923 g/cm³ in another embodiment, and from 0.916 g/cm³ to 0.922 g/cm³ in still another embodiment. The density of each of the polymer resins is determined in accordance with the procedure described in ASTM D 792-13.

In general, each of the polymer resins (e.g., Resin1, Resin2 and optionally Resin3) in the blend of resins used for forming the first polyolefin film layer 20 of the multilayer film 10 has a melt index (I₂) ranging from 0.5 g/10 min to 2.5 g/10 min in one embodiment; from 0.6 g/10 min to 2.1 g/10 min in another embodiment, from 0.8 g/10 min to 1.5 g/10 min in still another embodiment, and from 0.9 g/10 min to 1.2 g/10 min in yet another embodiment. The melt index (I₂) of each of the polymer resins is determined using the procedure described in ASTM D 1238-03 (at 190° C. and using a 2.16 kg weight).

In general, each of the polymer resins (e.g., Resin1, Resin2 and optionally Resin3) in the blend of resins used for forming the first polyolefin film layer 20 of the multilayer film 10 has a molecular weight distribution (Mw/Mn) ranging from 2 to 6 in one embodiment; from 3 to 5 in another embodiment; and from 3.5 to 4.5 in still another embodiment. The molecular weight (Mw) and molecular weight (Mn) of the LLDPE polymers is determined using gel permeation chromatography.

As an illustration of the present invention and not to be limited thereby, in some embodiments, the polymer resin blend composition for fabricating the first layer of the multilayer film, comprises a polymer resin blend composition including a mixture of Resin1 and Resin2 as follows:
(1) Resin1 comprises from 30 wt % to 98 wt % in one embodiment, from 55 wt % to 95 wt % in another embodiment, and from 85 wt % to 95 wt % in still another embodiment; and wherein Resin1 comprises a ZN-AMS-LLDPE resin; and
(2) Resin2 comprises from 25 wt % to 2 wt % in one embodiment, from 20 wt % to 5 wt % in another embodiment, and from 15 wt % to 8 wt % in still another embodiment, and wherein Resin2 comprises a LDPE resin.

In one general embodiment, the second film layer of the multilayer film useful in the present invention can be a monolayer or a combination of two or more monolayers (i.e., a multiple number of layers forming the second film layer of the multilayer film). In addition, the second film layer of the multilayer film useful in the present invention can be formed from a single polyolefin resin or a blend of two or more polyolefin resins. In one embodiment, the second film layer of the multilayer film is formed, for example, from one or more ethylene-based polymer components. In another embodiment, the second layer of the multilayer film is the core layer of the multilayer film.

In another embodiment, the second film layer of the multilayer film is a combination or blend of two or more ethylene-based polymer components selected from two or more of the above-described Resin1, Resin2 and optionally Resin3 which can be selected from the above-described resins (i) to (xii)). For example, in one embodiment, the second film layer of the multilayer film comprises a polymer resin blend composition of a blend of polyethylene-based resins such as a blend of: Resin1; and Resin2. Other optional resins that can be used, if desired, include for example, Resin3, a EZ-LLDPE resin; and/or a HDPE resin.

In one preferred embodiment, the polymer resin used for forming the second film layer of the multilayer film includes a single resin. With reference to FIG. 1 again, the single ethylene-based polymer resin for forming the second polyolefin film layer 30 of the multilayer film 10 includes a catalyzed LLDPE resin such as optional Resin3 described above.

In general, the polymer Resin3 used for forming the second polyolefin film layer 30 of the multilayer film 10 has a molecular weight distribution (Mw/Mn) ranging from 3 to 5 in one embodiment; and from 3.5 to 4.5 in still another embodiment. The weight-average molecular weight (Mw) and number-average molecular weight (Mn) of the Resin3 is determined using high temperature gel permeation chromatography.

As an illustration of the present invention and not to be limited thereby, in some embodiments, the polymer resin for fabricating the second layer of the multilayer film, comprises, for example, the above-described polymer Resin3; and the concentration of Resin3 is from 30 wt % to 100 wt % in one embodiment, from 65 wt % to 100 wt % in another embodiment, and from 85 wt % to 100 wt % in still another embodiment.

In one general embodiment, the third film layer of the multilayer film useful in the present invention can be a monolayer or a combination of two or more monolayers (i.e., a multiple number of layers forming the third film layer of the multilayer). In addition, the third film layer of the multilayer film useful in the present invention can be formed from a single polyolefin resin or a blend of two or more polyolefin resins. In one embodiment, the third film layer of the multilayer film is formed, for example, from one or more ethylene-based polymer components. In other embodiments, the third film layer of the multilayer film comprises a polymer resin blend composition that can be used to fabricate an outer layer (e.g., a second outer layer of the multilayer film) the same as the first film layer of the multilayer film or an outer layer different from the first film layer of the multilayer film. In other embodiments, the third layer of the multilayer film can be used as at least one inner layer of the multilayer film. When used as an inner layer, in a preferred embodiment, the third layer of the multilayer film can be a sealable skin layer. The third layer (as the second outer layer or the inner sealant layer of the multilayer film) can be the same or different than the first layer (being the first outer layer of the multilayer film).

With reference to FIG. 1 again, in one preferred embodiment, the polymer resin blend composition used for forming the third polyolefin film layer 40 of the multilayer film 10 may be the same polymer resin blend composition as the first film layer of the multilayer film; and includes a polymer resin blend composition of Resin1 and Resin2; and optionally Resin3. Resin1, Resin2, and optional Resin3 are described herein above. As an illustration of the present invention, and not to be limited thereby, in some embodiments, the polymer resin blend composition is used for fabricating a sealable inner layer as the third film layer of the multilayer film.

In a general embodiment, the process used for producing the at least three-layer multilayer film structure of the present invention includes the use of any conventional equipment and processes, known to those skilled in the art, such as for example, techniques utilized to prepare blown films using blow extrusion, extruded films using co-extrusion, and/or cast films using cast extrusion. Alternatively, the multilayer film structures of the present invention can be produced by incorporating the multilayer film in laminated structures.

In some embodiments, when the polymer resin composition comprises two or more components for each of the layers, the polymer components are first mixed together to form a blend. For example, the individual components may be dry blended and subsequently uniformly melt mixed in a mixer; or the components may be uniformly mixed together directly in a mixer, such as, for example, a Banbury mixer, a Haake mixer, a Brabender internal mixer, or a single or twin-screw extruder, which can include a compounding extruder and a side-arm extruder. After mixing the two or more components to form a polymer blend, the polymer blend is processed into a film structure.

In some embodiments, for example, multilayer films can be made using a co-extrusion process. In co-extrusion, a plurality of molten polymer streams is fed to an annular die (or flat cast) resulting in a multilayered film on cooling. In a preferred embodiment, the first polymer resin blend composition, the second polymer resin blend composition, and the third polymer resin blend composition used for preparing the first layer of the multilayer film, the second layer of the multilayer film, and the third layer of the multilayer film, respectively, of the present invention, are processed through a blown film process using a typical blowing process and equipment known to those skilled in art of blown film methods and the art of manufacturing multilayer films. For example, in one or more embodiments, the process of manufacturing the multilayer film of the present invention may include forming a blown film bubble by blown film extrusion. In some embodiments, the blown film bubble may be a multilayer blown film bubble. Further in accordance with this embodiment, the multilayer blown film bubble may include at least three layers (in accordance with the first layer of the multilayer film, the second layer of the multilayer film, and the third layer of the multilayer film described above), and the at least three layers may adhere to each other. In other embodiments, multilayer films comprising more than three layers such as five layers, seven layers and the like may be produced using a blown film bubble.

In some embodiments, for example, a blown film bubble may be formed via a blown film extrusion line wherein an extruded film coming from an extruder die may be formed (blown) and pulled up a tower onto a nip. The film may then be wound onto a core. Before the film is wound onto the core, the ends of the film may be cut and folded using folding equipment so that the layers of the film are difficult to separate, which may be important for shipping applications, generally, or heavy-duty shipping sack applications. Other embodiments of the blown film process may include using a blown film extrusion line having: (1) a length to diameter (“L/D”) ratio of, for example, from 30 to 1; (2) a blow-up ratio of, for example, from 1 to 5; (3) a die with internal bubble cooling; (4) a die gap of, for example, from 1 millimeter (mm) to 5 mm; and (5) a film thickness gauge scanner wherein the overall thickness of the multilayer film may be maintained at <1,000 μm as described above. In one general embodiment, the forming of the multilayer blown film bubble step may occur, for example, at a temperature of from 180° C. to 260° C.; and the output speed of the process may be, for example, from 10 kg/hr to 1,000 kg/hr.

The multilayer films of the present invention exhibit several advantageous properties and benefits over films previously known in the art. For example, the present invention multilayer films show improved performance and mechanical properties including increased toughness, good dart strength, increased stiffness, good processability and bubble stability when preparing blown films comprising the multilayer films of the present invention; increased mechanical and abuse resistance properties to withstand the forces and loads the multilayer films of the present invention may be subjected to; and increased impact and tear resistance.

In some embodiments, when the polymer resin blend composition of at least one layer of the multilayer film contains a ZN-AMS-LLDPE resin, in one general embodiment the layer formed from the composition containing the ZN-AMS-LLDPE resin advantageously exhibits at least a 10% improvement in toughness strength in terms of dart strength as compared to a multilayer film made from a resin composition that either (1) does not contain the ZN-AMS-LLDPE resin of the present invention; (2) contains too much of the ZN-AMS-LLDPE resin; or (3) contains too little of the ZN-AMS-LLDPE resin.

In other embodiments, the multilayer film formed from a polymer resin blend composition containing a ZN-AMS-LLDPE resin of the present invention exhibits at least a 15% improvement in toughness (or dart strength) as compared to a multilayer film made from a resin composition that does not contain the ZN-AMS-LLDPE resin of the present invention; and in still other embodiments, the multilayer film formed from a polymer resin blend composition containing a ZN-AMS-LLDPE resin of the present invention exhibits at least a 20% improvement in toughness (or dart strength) as compared to a multilayer film made from a resin composition that does not contain the ZN-AMS-LLDPE resin of the present invention.

In yet other embodiments, the multilayer film formed from a polymer resin blend composition containing a ZN-AMS-LLDPE resin of the present invention exhibits from 10% to 50% improvement in toughness (or dart strength) as compared to a multilayer film made from a resin composition that does not contain the ZN-AMS-LLDPE resin of the present invention; and in even still other embodiments, the multilayer film formed from the polymer resin blend composition containing a ZN-AMS-LLDPE resin of the present invention exhibits at least from 10% to 30% improvement in toughness (or dart strength) as compared to a multilayer film made from a resin composition that does not contain the ZN-AMS-LLDPE resin of the present invention.

Other performance properties of the multilayer films including tear resistance (in the machine direction (MD) and the cross direction (CD)), secant modulus, stiffness, and bubble stability is increased or maintained without deleterious effects.

The above improved properties of the multilayer films may allow the production of the films using less materials (“downgauging,” i.e., using thinner film thicknesses) where the effect of down-gauging is not detrimental to certain properties of the film. For example, the physical properties of the multilayer film, such as dart/bag drop, puncture, tear, and creep resistance, may still be maintained and may still meet customer and industry requirements even at reduced thicknesses.

In some embodiments, the multilayer film structure of the present invention can be used to produce end use products and articles useful for any number of applications. Exemplary end uses can include, but are not limited to, multilayer films, multilayer film-based products, and articles fabricated from the multilayer films and/or multilayer film-based products such as packaging applications. For example, in a preferred embodiment, the multilayer film structures of the present invention are used to produce heavy-duty bags (or heavy-duty shipping sacks utilized in shipping applications); and the heavy-duty bags are prepared by techniques known to those skilled in the art of bag production, such as for example, vertical form fill and seal equipment.

### Examples

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The Inventive Examples of the present invention are identified by Arabic numerals and the Comparative Examples are represented by letters of the alphabet. The following experiments analyze the performance of embodiments of compositions described herein. Unless otherwise stated all parts and percentages are by weight on a total weight basis.

### Raw Materials

The raw materials/ingredients used in the Examples include the polymer resins, Resins A-D, described as follows:

### Resin A

Resin A (an example of Resin3) is a LLDPE catalyzed by UCAT™ J (a catalyst commercially available from Univation). Resin A was prepared using the following Resin A Preparation method.

### Resin A Preparation

UCAT™ J Catalyst was injected into a gas phase polymerization reactor in the presence of ethylene, butene, hydrogen, nitrogen, and isopentane, whereby the reactor contents undergo polymerization to form a polyethylene and butene copolymer. The reaction was carried out at the reactor conditions described in Table I. The resin was then purged under nitrogen to remove residual hydrocarbons. Then, the resin was compounded with other ingredients using a twin screw extruder LCM100 and an underwater pelletizing cutter hub. The aforementioned other ingredients which were added to the resin were 600 ppm of Irgafos®168 and 1,300 ppm of Preblend 9K (both additives are available from BASF).

### Resin B

Resin B (an example of Resin1) is a LLDPE catalyzed by the catalyst disclosed in WO2019241044 Inventive Example 1a (IE 1a) except that the catalyst used to catalyze the LLDPE to produce Resin B was prepared at a commercial scale. Resin B was prepared using the following Resin B Preparation method.

### Resin B Preparation

The catalyst disclosed in WO2019241044 Inventive Example 1a (IE 1a) and produced at a commercial scale was injected into a gas phase polymerization reactor in the presence of ethylene, butene, hydrogen, nitrogen, and isopentane, whereby the reactor contents undergo polymerization to form a polyethylene and butene copolymer. The reaction was carried out at the reactor conditions described in Table I. The resin was then purged under nitrogen to remove residual hydrocarbons.

Then, the resin was compounded with other ingredients using a twin screw extruder LCM100 and an underwater pelletizing cutter hub. The aforementioned other ingredients which were added to the resin were 600 ppm of Irgafos®168 and 1,300 ppm of Preblend 9K (both additives are available from BASF).

### Resin C

Resin C (an example of Resin1) is a LLDPE catalyzed by the catalyst disclosed in WO2019241044 Inventive Example 1b (IE 1b) except that the catalyst used to catalyze the LLDPE to produce Resin C was prepared at a commercial scale. Resin C was prepared using the following Resin C Preparation method.

### Resin C Preparation

The catalyst disclosed in WO2019241044 Inventive Example 1b (IE 1b) and produced at a commercial scale was injected into a gas phase polymerization reactor in the presence of ethylene, butene, hydrogen, nitrogen, and isopentane, whereby the reactor contents undergo polymerization to form a polyethylene and butene copolymer. The reaction was carried out at the reactor conditions described in Table I. The resin was then purged under nitrogen to remove residual hydrocarbons.

Then the resin was compounded with other ingredients using a twin-screw extruder LCM100 and an underwater pelletizing cutter hub. The aforementioned other ingredients which were added to the resin were 600 ppm of Irgafos®168 and 1,300 ppm of Preblend 9K (both additives are available from BASF).

### Resin D

Resin D (an example of Resin2) is a low density polyethylene resin, LDPE 450E, having a melt index of 2 gram/10 min and having a density of 0.923 gram/cm³. LDPE 450E is commercially available from The Dow Chemical Company.

The reactor conditions described in Table I were used to prepare Resins A, B and C.

TABLE I
Reactor Conditions for Preparing Resins A, B and C

| Condition/Parameter | Resin A | Resin B | Resin C |
|---|---|---|---|
| Production Rate [kg/h] | 4,080 | 3,220 | 2,990 |
| Bed Weight [kg] | 14,180 | 11,540 | 14,520 |
| Residence Time [hr] | 3.5 | 3.6 | 4.9 |
| Reactor Pressure [Pa] | 1.68 × 10⁶ | 1.60 × 10⁶ | 1.80 × 10⁶ |
| Superficial Gas Velocity [m/s] | 0.539 | 0.546 | 0.533 |
| C2PP [psia] | 690,900 | 690,900 | 688,100 |
| Bed Temperature [° C.] | 85.6 | 85.8 | 85.8 |
| H₂/C2 Ratio [mol/mol] | 0.156 | 0.203 | 0.259 |
| C4/C2 Ratio [mol/mol] | 0.386 | 0.387 | 0.344 |
| Al/Ti Ratio [mol/mol] | 38 | 117 | 116 |
| C2 Mol % | 38.89 | 40.56 | 36.16 |
| C4 Mol % | 14.99 | 15.69 | 12.47 |
| H₂ Mol % | 6.09 | 8.22 | 9.33 |
| IC5 Mol % | 0.12 | 0.06 | 0.17 |
| N₂ Mol % | 39.98 | 36.25 | 42.13 |

In Table I above, “C2PP” is ethylene partial pressure, “C2” is ethylene, “C4” is 1-Butene, and “IC5” is isopentane.

Some properties of Resins A-D are described in Table 11 and some properties of Resins A-C are described in Table Ill.

TABLE II
Properties of Resins A-D

| | MI | Density | |
|---|---|---|---|
| Resin | (g/min) | (g/cc) | Comonomer |
| Resin A | 1.8 | 0.919 | 1-butene |
| Resin B | 1.8 | 0.920 | 1-butene |
| Resin C | 2.0 | 0.919 | 1-butene |
| Resin D | 2.0 | 0.923 | — |

TABLE III
Properties of Resins A-C

| | | | | R2* of | CDBI | α⁽¹⁾ | β⁽²⁾ | γ⁽³⁾ | | |
|---|---|---|---|---|---|---|---|---|---|---|
| Resin | Mw/Mn | Mz/Mw | CUMCDI | CUMCDI | (%) | (wt %) | (wt %) | (wt %) | δ⁽⁴⁾ | Mw⁽⁵⁾ |
| Resin A | 4.20 | 3.51 | −0.49 | 0.75 | 43.5 | 8.6 | 12.1 | 45.2 | 0.267 | 1.960 |
| Resin B | 4.12 | 3.44 | −0.35 | 0.58 | 43.8 | 6.9 | 12.2 | 47.7 | 0.256 | 1.924 |
| Resin C | 3.82 | 3.14 | −0.62 | 0.84 | 44.5 | 7.3 | 11.0 | 48.1 | 0.230 | 1.618 |

Notes for Table III:
⁽¹⁾α = wt % measured by the iCCD method at 25.0° C. to 37.0° C.
⁽²⁾β = wt % measured by the iCCD method at 93.0° C. to 120.0° C.
⁽³⁾γ = wt % measured by the iCCD method at 75.0° C. to 93.0° C.
⁽⁴⁾δ = ratio of wt % measured at 93.0° C. to 120.0° C. divided by wt % measured at 75.0° C. to 93.0° C. by the iCCD method
⁽⁵⁾Mw = ratio of Mw of the fraction eluting between 93.0° C. to 120.0° C. divided by the Mw of the whole polymer eluting from 25.0° C. to 120.0° C.

### Resin Blends

The polymer resin blend compositions used in the Examples include three different samples of catalyzed LLDPEs; and the catalysts used to form the catalyzed LLDPE include: (1) UCAT J catalyst which forms a catalyzed LLDPE which is referred to in the Examples as “UCAT J-LLDPE”, (2) ZN1 catalyst which forms the catalyzed AMS-LLDPE, and (3) ZN2 catalyst which forms another catalyzed AMS-LLDPE. Each of the three catalyzed LLDPE resins are blended with a LDPE resin having a MI of 2. The resin blends used in the Examples are described generally in Table IV.

### General Procedure for Preparing the Resin Blends

The resin components described in Formulation UJ-LDPE, Formulation ZN1-LDPE, Formulation ZN2-LDPE were used in the Examples; and the percentages of each of the resin components used to prepare the polymer resin blend formulations of the Examples are described. The resin components were mixed together, in the concentrations specified, using a conventional mixing apparatus and process. The mixing was carried out at a room temperature. The resultant blend/mixture of resin components (i.e., the prepared polymer resin blend formulations) were then used to manufacture each of the individual layers of the multilayer film structures.

The resin blends prepared in accordance with the procedures above are described in Table IV.

TABLE IV
Resin Blends

| Resin Blend | Resin A | Resin B | Resin C | Resin D |
|---|---|---|---|---|
| No. | (wt %) | (wt %) | (wt %) | (wt %) |
| Blend1 | 90 | | | 10 |
| Blend2 | 100 | | | |
| Blend3 | | 90 | | 10 |
| Blend4 | | 100 | | |
| Blend5 | | | 90 | 10 |
| Blend6 | | | 100 | |

### Multilayer Films

In general, each of the layers of the 3-layer multilayer films, Film1-Film3, described in Tables V-VII are prepared using the various resin blends, Blend1-Blend6 described above. As aforementioned, the individual polymer resins, Resin A-D, are used to form the polymer resin blends, Blend1-Blend6, which in turn, are used to form the individual layers of the 3-layer film structures, Film1-Film3, described in Tables V-VII.

TABLE V
3-Layer Film1 Using Various Blends (Comparative Example A)

| | Thickness | Resin Blend |
|---|---|---|
| Film Layer | (μm) | No. |
| Out Layer | 16.7 | Blend1 |
| Middle Layer | 16.6 | Blend2 |
| Inside Layer | 16.7 | Blend1 |

TABLE VI
3-Layer Film2 Using Various Blends (Inventive Example 1)

| | Thickness | Resin Blend |
|---|---|---|
| Film Layer | (μm) | No. |
| Out Layer | 16.7 | Blend3 |
| Middle Layer | 16.6 | Blend4 |
| Inside Layer | 16.7 | Blend3 |

TABLE VII
3-Layer Film2 Using Various Blends (Inventive Example 2)

| | Thickness | Resin Blend |
|---|---|---|
| Film Layer | (μm) | No. |
| Out Layer | 16.7 | Blend5 |
| Middle Layer | 16.6 | Blend6 |
| Inside Layer | 16.7 | Blend5 |

### General Procedure for Fabricating Multilayer Films

The process for preparing a multilayer film structure described in Tables V-VII includes the following:

Samples of the three-layer multilayer film structures, Film1-Film3, described in Tables V-VII were manufactured using an Alpine 7-layer blown film line including 7 extruders as described in Table VIII. The film extruder line parameters are described in Table IX. The 7-layer blown film line was used to form 7 film layers; and the 7 film layers were used to produce the 3-layer multilayer film samples. Each of the 7 individual films layers was first produced by each of the 7 individual extruders as described in Table VIII; and then, the 7 layers from the extruders were brought together to form the 3-layer film structure identified, for example, as an inner layer, a middle layer and an outer layer of the 3-layer multilayer film structures as described in Tables V-VII. The parameters of the extruders described in Table IX include operating the extruders at a melt temperature of from 403° F. (206° C.) to 480° F. (249° C.) at an output rate of 310 lbs/hr (141 kg/hr) (3-layer coextrusion).

### Processing Parameters for Film Production

TABLE VIII
Alpine 7 Layer Film Line

| | | Thickness Ratio |
|---|---|---|
| Extruder No. | Layer | (%) |
| Extruder 1 | Outer layer | 16.7 |
| Extruder 2 | | 16.7 |
| Extruder 3 | Middle layer | 11.1 |
| Extruder 4 | | 11.1 |
| Extruder 5 | | 11.1 |
| Extruder 6 | Inner layer | 16.7 |
| Extruder 7 | | 16.7 |

TABLE IX
Film Extruder Line Parameters

| | |
|---|---|
| Die Size: | 9.84 in (25 cm) |
| Die Gap: | 78.7 mil (2 mm) |
| Blow Up Ratio (BUR): | 2.5 |
| Frost Line Height | 35 in (89 cm) |
| Output Rate: | 310 lbs/hr (141 kg/hr) |

### Measurements and Test Methods

### Film Characterization

The testing standards listed in Table X were used to characterize the film structures prepared using the polymer resin formulations described above and used in the Examples.

TABLE X
Testing Standards for Film Characterization

| Property Tested | Standard |
|---|---|
| Zebedee Clarity | ASTM D1746-15 |
| Clarity | ASTM D1746-15 |
| Haze | ASTM D1003-13 |
| Gloss | ASTM D2457-21 |
| Secant Modulus-CD | ASTM D882-18 |
| Secant Modulus-MD | ASTM D882-18 |
| Tear: Elmendorf-CD | ASTM D1922-15 |
| Tear: Elmendorf-MD | ASTM D1922-15 |
| Puncture | ASTM D5748-95 |
| Dart Drop Impact | ASTM D1709-18 |

### Density

Resin density was measured by the Archimedes displacement method, ASTM D 792-13, Method B, in isopropanol. Specimens (samples) for this test were measured 40 hr after molding and after conditioning in an isopropanol bath at 23° C. for 8 min to achieve thermal equilibrium prior to measurement. The specimens were compression molded in a press according to ASTM D 4703-16 Annex A, with a 5 min initial heating period at approximately 190° C., and a 15° C./min cooling rate per Annex A Procedure C. The specimens were cooled to 45° C. in the press with continued cooling until the specimens reached room temperature.

### Melt Flow Rate

Melt flow rate measurements were performed according to the procedure described in ASTM D-1238-03 at the following three different conditions: (1) at 190° C. and 2.16 kg, (2) at 190° C. and 5.0 kg, and (3) at 190° C. and 21.6 kg; and the three melt flow rate measurements are designated as I₂, I₅, and I₂₁, respectively. As known to those skilled in the art, melt flow rate is inversely proportional to the molecular weight of a polymer being measured. Thus, the higher the molecular weight of a polymer, the lower the melt flow rate of the polymer, although the relationship is not linear. The melt flow rate at 2.16 kg is also referred herein as melt index (I₂)

### High Temperature Gel Permeation Chromatography

High Temperature Gel Permeation Chromatography (GPC) was performed on the specimens to determine the Molecular Weight Distributions (MWD) of the samples and the samples' corresponding moments (Mn, Mw and Mz). The chromatographic system used to measure GPC included a Polymer Char GPC-IR high temperature GPC chromatograph (available from Polymer Char, Valencia, Spain) equipped with a 4-capillary differential viscometer detector and a IR5 multi-fixed wavelength infrared detector (available from Polymer Char). A Precision Detectors 2-angle laser light scattering detector Model 2040 (available from Precision Detectors, currently Agilent Technologies) was added to the chromatographic system. The 15-degree angle of the light scattering detector was used for calculation purposes. Data collection was performed using GPC One software (available from Polymer Char). The system was equipped with an on-line solvent degas device (available from Precision Detectors, currently Agilent Technologies).

Both the detector compartments and the column compartment of the chromatograph were operated at 150° C. The columns used were 4 PLgel Mixed A 7.5 mm×300 mm, 20-micron columns (Agilent Technology). The chromatographic solvent used was 1,2,4 trichlorobenzene (TCB) which contained 200 ppm of butylated hydroxytoluene (BHT). The solvent source was nitrogen sparged. The injection volume used for each of the injection samples was 200 μL and the flow rate was 1.0 mL/min. Otherwise stated, samples were prepared in a semi-automatic manner with the PolymerChar “Instrument Control” Software, wherein the samples were weight-targeted at 2 mg/mL, and the solvent (contained 200 ppm BHT) was added to a pre nitrogen-sparged septa-capped vial, via the PolymerChar high temperature autosampler. The samples were dissolved for 2 hr at 160° C. under “low speed” shaking.

For conventional molecular weight measurements, the GPC column set was calibrated with 21 narrow molecular weight distribution polystyrene standards (available from Polymer Laboratories, now Varian) with molecular weights ranging from 580 to 8,400,000 and were arranged in 6 “cocktail” mixtures. The polystyrene standards were prepared at 0.025 g in 50 mL of solvent for molecular weights ≥1,000,000; and 0.05 g in 50 mL of solvent for molecular weights <1,000,000. The polystyrene standards were dissolved at 80° C. with gentle agitation for 30 min. The narrow standards mixtures were run first and in decreasing order from the highest molecular weight component to minimize degradation of the standards. The peak molecular weights of the polystyrene standards were converted to polyethylene molecular weights using the following Equation (1):

$${M}_{polyethylene} = A * {( {M}_{polystyrene} )}^{⋀} B \qquad Equation ( I )$$

where in Equation (1), “M” is molecular weight of polystyrene or polyethylene; value “A” is a positive number of <0.500; and value “B” is equal to 1.000. A fifth order polynomial was used to fit the respective polystyrene calibration points. The MWD can be also expressed in integral form as cumulative weight distribution versus log (molecular weight) (Streigel et al., Modern Size Exclusion Liquid Chromatography, 2^{nd} edition, P450) from zero to 1.00 for the entire MWD range from lowest MW to highest MW.

A calibration for the IR5 detector rationing was performed using at least ten ethylene-based polymer short chain branching (SCB) standards, where octene is used as the comonomer. Polymer properties for the SCB standards are shown in Table XI. Each of the SCB standards are made by single-site metallocene catalyst from a single reactor in solution process (polyethylene homopolymer and ethylene/octene copolymers) of a narrow short chain branching distribution (SCBD) and known comonomer content (as measured by ¹³C NMR Method, Qiu et al., Anal. Chem. 2009, 81, 8585-8589), ranging from homopolymer (0 SCB/1000 total C) to approximately 40 SCB/1000 total C, where total C=carbons in backbone+carbons in branches. Each SCB standard had a weight-average molecular weight from 36,000 g/mole to 126,000 g/mole measured by GPC. Also, each SCB standard had a molecular weight distribution (Mw/Mn) from 2.0 to 2.5 as described in Table XI.

TABLE XI
SCB Standards

| Octene Comonomer | | | |
|---|---|---|---|
| (wt %) | SCB/1000 Total C | Mw | Mw/Mn |
| 23.1 | 28.9 | 37,300 | 2.22 |
| 14.0 | 17.5 | 36,000 | 2.19 |
| 0.0 | 0.0 | 38,400 | 2.20 |
| 35.9 | 44.9 | 42,200 | 2.18 |
| 5.4 | 6.8 | 37,400 | 2.16 |
| 8.6 | 10.8 | 36,800 | 2.20 |
| 39.2 | 49.0 | 125,600 | 2.22 |
| 1.1 | 1.4 | 107,000 | 2.09 |
| 14.3 | 17.9 | 103,600 | 2.20 |
| 9.4 | 11.8 | 103,200 | 2.26 |

A “IR5 Area Ratio” (or “IR5 Methyl Channel Area/IR5 Measurement Channel Area”) of a “baseline-subtracted area response of a IR5 methyl channel sensor” to a “baseline-subtracted area response of IR5 measurement channel sensor” was calculated for each of the SCB standards (standard filters and filter wheel are as supplied by PolymerChar: Part Number IR5 FWM01 included as part of the GPC-IR instrument). A linear fit of the SCB frequency versus the IR5 Area Ratio was constructed in the form of the following Equation (II):

$$Equation ( II )$$

$$SCB / 1000 total C = {A}_{0} + [ {A}_{1} \times ( IR {5}_{Methyl Channel Area} / IR {5}_{Measurement Channel Area} ) ]$$

where A₀ is the SCB/1000 total C intercept at an IR5 Area Ratio of zero, and A₁ is the slope of the SCB/1000 total C versus the IR5 Area Ratio. A₁ represents the increase in the SCB/1000 total C as a function of the IR5 Area Ratio. The IR5 Area Ratio is equal to a IR5 Height Ratio for narrow PDI and narrow SCBD standard materials.

A series of “linear baseline-subtracted chromatographic heights” for the chromatogram generated by the “IR5 methyl channel sensor” was established as a function of column elution volume to generate a “baseline-corrected chromatogram (methyl channel)”. A series of linear baseline-subtracted chromatographic heights for the chromatogram generated by the “IR5 measurement channel” of the IR-5 detector was established as a function of column elution volume to generate a “base-line-corrected chromatogram (measurement channel”).

A “IR5 Height Ratio” of the “baseline-corrected chromatogram (methyl channel)” to the “baseline-corrected chromatogram (measurement channel)” was calculated at each column elution volume index (each equally-spaced index, representing 1 data point per second at 1 mL/min elution flow rate) across the sample integration bounds. The IR5 Height Ratio was multiplied by the coefficient A₁, and the coefficient A₀ was added to this result, to produce the predicted SCB frequency of the sample. The result was converted into mole percent comonomer using the following Equation (Ill):

$$Equation ( III )$$

$$Mole Percent Comonomer = \{ {SCB}_{f} / [ {SCB}_{f} + ( ( 1 \; 000 - {SCB}_{f} ⋆ Length of comonomer ) / 2 ) ] \} ⋆ 100$$

where “SCB_{f}” is the “SCB per 1000 total C”, and the “Length of comonomer” is 8 which is the number of carbons of octene.

The comonomer composition versus MWD was reported as octene comonomer. Each elution volume index was converted to a molecular weight (Mwᵢ) value using the method described above; Equation (II). The “Mole Percent Comonomer (y axis)” was calculated as a function of Log (Mwᵢ), and the slope was calculated between the cumulative weight fraction at 0.10 to 0.95. (An EXCEL linear regression was used to calculate the slope and R² (coefficient of linear fitting) between the cumulative weight fraction at 0.10 to 0.95). This slope is defined as the cumulative molecular weight comonomer distribution index (CUMCDI).

iCCD Method

The term “iCCD” refers to an improved method for comonomer content distribution (CCD) analysis; and is based on the method described in WO2017040127A₁. The test method was performed with crystallization elution fractionation (CEF) instrumentation (available from Polymer Char) equipped with an IR-5 detector and a two-angle precision detector light scattering detector Model 2040 (available from Agilent Technology). Ortho-dichlorobenzene (ODCB, 99% anhydrous grade or technical grade) was used as solvent. Silica gel 40 (with a particle size of 0.2 mm to ˜0.5 mm; available from EMD Chemicals) can be used to dry the ODCB solvent. Dried silica was packed into three emptied HT-GPC columns (with dimensions of 300 mm×7.5 mm (ID)) to further purify the ODCB solvent as eluent. The CEF instrument is equipped with an autosampler with nitrogen (N₂) purging capability. ODCB was sparged with dried N₂ for 1 hr before use.

A sample was prepared using the autosampler at 4 mg/mL (unless otherwise specified) under shaking at 160° C. for 1 hr. The injection volume of the sample was 300 μL. The temperature profile of iCCD was as follows: crystallization at 3° C./min from 105° C. to 30° C.; thermal equilibrium at 30° C. for 2 min (including Soluble Fraction Elution Time being set as 2 min); elution at 3° C./min from 30° C. to 140° C. The flow rate of the sample during crystallization is 0.0 mL/min. The flow rate of the sample during elution is 0.50 mL/min. The data was collected at one data point/second.

The iCCD column used was a 15 cm (length)×¼ in internal diameter (ID) stainless tubing packed with gold coated nickel particles (Bright 7GNM8-NiS; available from Nippon Chemical Industrial Co.). The column packing and conditioning was carried out using a slurry method according to the method described in WO2017040127A₁. The final pressure with trichlorobenzene (TCB) slurry packing was 150 bar (10 MPa).

The column temperature calibration was performed by using a mixture of: (i) 1.0 mg/mL of a linear homopolymer polyethylene (a polyethylene having a zero comonomer content, a melt index (I₂) of 1.0 g/cm³, and a polydispersity (M_{w}/Mₙ) of approximately 2.6 as determined by the GPC test method described above) as a “reference material”; and (ii) 2 mg/mL of Eicosane in ODCB. The iCCD temperature calibration consisted of four steps: (1) calculating the delay volume defined as the temperature offset between the measured peak elution temperature of Eicosane minus 30.00° C.; (2) subtracting the temperature offset of the elution temperature from iCCD raw temperature data (it is noted that this temperature offset is a function of experimental conditions, such as elution temperature, elution flow rate, etc.); (3) creating a linear calibration line transforming the elution temperature across a range of 30.00° C. and 140.00° C. so that the linear homopolymer polyethylene reference material had a peak temperature at 101.0° C., and Eicosane had a peak temperature of 30.0° C.; (4) for the soluble fraction measured isothermally at 30° C., the elution temperature below 30.0° C. is extrapolated linearly by using the elution heating rate of 3° C./min according to the method described in U.S. Pat. No. 9,688,795. GPCOne software (available from PolymerChar) is used to generate SCBD distribution curve dWi/dT where Wi is the mass at mass at Ti, where T is the elution temperature after calibration.

The elution fraction, in wt %, is determined at a specific elution temperature range. It is defined as the area of the baseline subtracted iCCD profile in a specific temperature range divided by the total integrated area of the baseline subtracted iCCD elution chromatogram multiplying by 100%. For example, wt % (in the elution temperature range of 75.0° C. to 93.0° C.) is defined as the area of the baseline subtracted iCCD chromatogram eluting from 75.0° C. to 93.0° C. divided by the total integrated area of iCCD chromatogram (from 25.0° C. to 120.0° C.) multiplied by 100%.

The comonomer content versus elution temperature of iCCD was constructed by using 12 reference materials (ethylene homopolymer and ethylene-octene random copolymer made with single site metallocene catalyst, having ethylene equivalent weight average molecular weight ranging from 35,000 to 128,000) with solution process. All of these reference materials were analyzed the same way as specified previously at 4 mg/mL. The correlation between comonomer mol fraction versus elution temperature (T in Celsius) follows the following expression:

In(1-comonomer mol fraction)=−208.328/(elution temperature+273.12)+0.55846.

The composition distribution index (CDBI) is defined as the weight percent of the polymer molecules having a co-monomer content within +/−50 percent of the median total molar co-monomer content (as reported in WO 93/03093). The CDBI of polyolefins can be conveniently calculated from the SCBD data obtained from the techniques known in the art, such as, for example, temperature rising elution fractionation (“TREF”) as described, for example, by Wild, et al., Journal of Polymer Science, Poly. Phys. Ed., Vol. 20, 441 (1982); L. D. Cady, “The Role of Comonomer Type and Distribution in LLDPE Product Performance,” SPE Regional Technical Conference, Quaker Square Hilton, Akron, OH, 107-119 (Oct. 1-2, 1985); and in U.S. Pat. Nos. 4,798,081 and 5,008,204.

Herein, CDBI is calculated accordingly by using short chain branching distribution measured by the iCCD method and with the comonomer composition correlation versus elution temperature as described above.

Molecular weight of polymer and the molecular weight of the polymer fractions was determined directly from a light scattering (LS) detector (Precision Detector, 90 degree angle) and concentration detector (IR-5) according Rayleigh-Gans-Debys approximation (Striegel and Yau, Modern Size Exclusion Liquid Chromatogram, Page 242 and Page 263) by assuming a form factor of 1 and all the virial coefficients equal to zero. Baselines were subtracted for both LS detector and concentration detector. Integration windows are set to integrate all the chromatograms in the elution temperature (temperature calibration is specified above) range of from 23.0° C. to 120° C.

The calculation of molecular weight (Mw) from iCCD includes the following steps:

Step (1): Measuring the interdetector offset (i.e., the volume difference between detectors). The offset is defined as the geometric volume offset between LS with respect to concentration detector. It is calculated as the difference in the elution volume (mL) of polymer peak between concentration detector and LS chromatograms. It is converted to the temperature offset by using elution thermal rate and elution flow rate. A linear high density polyethylene (having zero comonomer content, Melt index (I₂) of 1.0, polydispersity M_{w}/Mₙ approximately 2.6 by conventional gel permeation chromatography) is used. Same experimental conditions as the normal iCCD method above are used except the following parameters: crystallization at 10° C./min from 140° C. to 137° C., the thermal equilibrium at 137° C. for 1 minute as Soluble Fraction Elution Time, soluble fraction (SF) time of 7 minutes, elution at 3° C./min from 137° C. to 142° C. The flow rate during crystallization is 0.0 ml/min. The flow rate during elution is 0.80 ml/min. Sample concentration is 1.0 mg/ml.

Step (2): Each datapoint in LS chromatogram is shifted to correct for the interdetector offset before integration.

Step (3): Baseline subtracted LS and concentration chromatograms are integrated for the whole eluting temperature range of the Step (1). The MW detector constant is calculated by using a known MW HDPE sample in the range of 100,000 to 140,000 M_{w} and the area ratio of the LS and concentration integrated signals.

Step (4): M_{w} of the polymer was calculated by using the ratio of integrated light scattering detector (90-degree angle) to the concentration detector and using the MW detector constant. With the measured MW detector constant, NIST NBS 1475a analyzed with same method specified in (1) above gave molecular weight of 58,000.

Mw ratio is calculated as the M_{w} of the fraction eluting between 93.0° C. to 120.0° C. divided by the Mw of the whole polymer (eluting from 25.0° C. to 120.0° C.).

### Test Results

TABLE XII
Properties of a 3-Layer Films with a 2 Mil Thickness

| Example No.: | Comp. Ex. A | Inv. Ex. 1 | Inv. Ex. 2 |
|---|---|---|---|
| Film No.: | Film1 | Film2 | Film3 |
| | UCAT J-LDPE | ZN1-LDPE | ZN2-LDPE |
| Results | | | |
| Zebedee Clarity | 65.9 | 68.3 | 69.1 |
| Clarity, %: | 98.7 | 99.0 | 99.1 |
| Haze, % | 15.6 | 14.4 | 12.8 |
| Gloss | 48.0 | 49.9 | 53.9 |
| Secant 1% CD, psi/MPa | 49,429/341 | 53,489/369 | 49,014/338 |
| Secant 1% MD, psi/MPa | 42,171/291 | 44,019/304 | 43,202/298 |
| Puncture, J/m³ | 1.11 × 10⁷ | 1.27 × 10⁷ | 1.39 × 10⁷ |
| Elmendorf Tear CD, | 392/100 | 355/90 | 364/92 |
| gf/mil/kg/cm: | | | |
| Elmendorf Tear MD, | 152/39 | 158/40 | 155/39 |
| gf/mil/kg/cm | | | |
| Dart Impact Total Energy, J | 0.21 | 0.21 | 0.22 |

### Discussion of Results

The results described in Table XII show that the 3-layer multilayer film structures containing the combined polymer resins: ZN1-LLDPE resin with LDPE (Inv. Ex. 1) and ZN2-LLDPE resin with LDPE resin (Inv. Ex. 2), exhibit an improvement in the optical and puncture properties of the 3-layer multilayer film structure compared to the 3-layer multilayer film structures containing the combined polymer resins: UJ-LLDPE with LDPE (Comp. Ex. A). The other properties of the resins of Inv. Ex. 1 and Inv. Ex. 2 are either maintained (comparable or similar to) or improved when compared to the resins of Comp. Ex. A.

What is claimed is:

1. A multilayer film comprising at least three layers including:
(a) at least a first polyolefin film layer, wherein the first polyolefin film layer comprises a first outer film layer;
(b) at least a second polyolefin film layer, wherein the second polyolefin film layer comprises a core film layer; and
(c) at least a third polyolefin film layer, wherein the third polyolefin film layer comprises a second outer film layer; wherein the at least a third polyolefin film layer is the same or different than the at least first polyolefin film layer; wherein the at least second polyolefin film layer is disposed in between, and separates, the first and third polyolefin film layers; wherein the first, second, and third polyolefin film layers are contacted together to form at least a three-layer film structure;
wherein at least one of the polyolefin film layers of the multilayer film is prepared from a polymer blend composition comprising:
(i) at least a first ethylene-based polymer resin comprising a catalyzed linear low density polyethylene resin having an altered molecular structure prepared using a Ziegler-Natta Catalyst System 1, which is prepared as described in Preparation 1 in the description; and
(ii) at least a second ethylene-based polymer resin; wherein the at least second ethylene-based polymer resin comprises a low density polyethylene resin.

2. The multilayer film of claim 1, wherein at least one of the polyolefin film layers of the multilayer film includes a catalyzed linear low density polyethylene resin having an altered molecular structure prepared using a Ziegler-Natta Catalyst System 1, which is prepared as described in Preparation 1 in the description; and wherein the multilayer film having a polyolefin film layer which includes a catalyzed linear low density polyethylene resin having an altered molecular structure prepared using the Ziegler-Natta Catalyst System 1, exhibits at least a 10 percent increase in puncture resistance compared to the puncture resistance of polyolefin film layers of a multilayer film that include a catalyzed linear low density polyethylene resin having a non-altered molecular structure prepared using a Ziegler-Natta catalyst different from the Ziegler-Natta Catalyst System 1.

3. The multilayer film of claim 1, wherein the catalyzed linear low density polyethylene having an altered molecular structure is a copolymer of ethylene and 1-butene and is catalyzed using the Ziegler-Natta Catalyst System 1.

4. The multilayer film of claim 1, wherein one or more of the first polyolefin film layer, the second polyolefin film layer and the third polyolefin film layer of the multilayer film independently is a polyolefin film layer prepared from a polymer resin blend composition of:
(i) at least a first ethylene-based polymer resin; wherein the at least first ethylene-based polymer resin comprises a catalyzed linear low density polyethylene resin having an altered molecular structure prepared using the Ziegler-Natta Catalyst System 1; and
(ii) at least a second ethylene-based polymer resin; wherein the at least second ethylene-based polymer resin comprises a low density polyethylene resin.

5. The multilayer film of claim 1, wherein the catalyzed linear low density polyethylene resin having an altered molecular structure prepared using the Ziegler-Natta Catalyst System 1 has a melt index (MI) of from 0.8 g/10 min to 2.8 g/10 min and a density of from 0.910 g/cm³ to 0.935 g/cm³; and wherein the low density polyethylene resin of the multilayer film has a melt index of from 0.5 g/10 min to 2.5 g/10 min and a density of from 0.916 g/cm³ to 0.940 g/cm³.

6. The multilayer film of claim 1, wherein the catalyzed linear low density polyethylene resin having an altered molecular structure of the multilayer film: (a) is formed from a butene comonomer to form a poly(ethylene-co-1-butene) copolymer resin; (b) is made by a gas phase process using Ziegler-Natta Catalyst System 1, which is prepared as described in Preparation 1 in the description that forms a catalyzed linear low density polyethylene resin having an altered molecular structure; (c) has a density of from 0.910 g/cm³ to 0.935 g/cm³; (d) has a melt index of from 0.8 g/10 min to 2.8 g/10 min; (e) has a molecular weight distribution (M_{w}/Mₙ) of greater than 3.0; (f) has a M_{z}/M_{w} of greater than 2.5; (g) has a cumulative molecular weight comonomer distribution index of less than 0.1; (h) has a weight percent eluting from 93.0° C. to 120.0° C. divided by the weight percent eluting between 75.0° C. to 93.0° C., as measured by iCCD, in the range of from 0.13 to 0.26 (i) optionally, a weight percent eluting from 25.0° C. to 37.0° C., as measured by iCCD, in the range of 6.0 percent to 8.0 percent; (j) optionally, a weight percent eluting from 75.0° C. to 93.0° C., as measured by iCCD of more than 41.5 percent; and (k) optionally, is produced using a Zeigler-Natta (pro)catalyst system prepared by a gas phase process.

7. The multilayer film of claim 1, wherein the low density polyethylene resin of the multilayer film structure has: (a) a density of from 0.915 g/cc to 0.925 g/cc; and (b) a melt index of from 0.8 g/10 min to 2.5 g/10 min.

8. The multilayer film of claim 1, wherein the multilayer film has a puncture resistance value ranging from 1.15×10⁷ J/m³ to 1.75×10⁷ J/m³.

9. The multilayer film of claim 1, wherein the at least first polyolefin film layer is from 20 percent to 40 percent of the total film structure; wherein the at least second polyolefin film layer is from 20 percent to 60 percent of the total film structure; and wherein the at least third polyolefin layer is from 20 percent to 40 percent of the total film structure.

10. The multilayer film of claim 1; wherein each of the at least first polyolefin film layer, the at least second polyolefin film layer, and the at least third polyolefin film layer is either a mono-layer or a multilayer.

11. A packaging article for use in packaging applications comprising the multilayer film of claim 1.

12. The packaging article of claim 11; wherein the packaging article is a heavy-duty packaging bag.

13. A process for producing the multilayer film of claim 1 comprising contacting together at least three film layers including:
(a) at least a first polyolefin film layer, wherein the first polyolefin film layer comprises a first outer film layer;
(b) at least a second polyolefin film layer, wherein the second polyolefin film layer comprises a core film layer; and
(c) at least a third polyolefin film layer, wherein the third polyolefin film layer comprises a second outer film layer; wherein the at least third polyolefin film layer is the same or different than the at least first polyolefin film layer; wherein the at least second polyolefin film layer is disposed in between, and separates, the first and third film layers; wherein the first, second and third film layers are contacted together to form at least a three-layer film structure; and wherein at least one of the polyolefin film layers of the at least three-layer film structure is prepared from a polymer composition containing at least one ethylene-based polymer resin comprising a catalyzed linear low density polyethylene resin having an altered molecular structure prepared using a Ziegler-Natta Catalyst System 1, which is prepared as described in Preparation 1 in the description.

14. A polymer resin blend composition for making the multilayer film of claim 1, wherein the polymer resin blend composition comprises a blend of two or more polyethylene-based polymer resins including:
(i) at least a first ethylene-based polymer resin comprising a catalyzed linear low density polyethylene resin having an altered molecular structure prepared using a Ziegler-Natta Catalyst System 1, which is prepared as described in Preparation 1 in the description; and
(ii) at least a second ethylene-based polymer resin comprising a low density polyethylene resin.
